(19) United States
(12) Patent Application Publication
(10) Pub. No.: US 2026/0338965 A1
(43) Pub. Date: Oct. 29, 2026

(54) NAVIGATION USING A SIGNAL OF OPPORTUNITY

(71) Applicant: Raytheon Systems Limited, Harlow (GB)

(72) Inventor: Grant Maclean, Glencoe (GB)

(21) Appl. No.: 19/704,216

(22) Filed: Jun. 10, 2026

Related U.S. Application Data
(63) Continuation of application No. PCT/GB2024/053121, filed on Dec. 13, 2024.

(30) Foreign Application Priority Data
Dec. 15, 2023 (GB) 2319305.5

(51) Int. Cl. G01S 19/47; G01S 19/43

(52) U.S. Cl. CPC G01S 19/47; G01S 19/43

(57) ABSTRACT

A method for determining a position of a device includes receiving one or more signals of opportunity. Each signal of the one or more signals of opportunity originates from a different transmission source of one or more transmission sources. At least one transmission source of the one or more transmission sources is a moving transmission source moving relative to the earth. The method also includes determining an identity of each transmission source of the one or more transmission sources based on the respective signal of the one or more signals of opportunity. The method further includes obtaining position data for each transmission source based on the identity of the transmission source. In addition, the method includes determining the position of the device based on a respective property of each signal of the one or more signals of opportunity and the position data for each of the one or more transmission sources.

### CROSS-REFERENCE TO RELATED APPLICATIONS AND PRIORITY CLAIM

This application claims priority as a continuation of International Patent Application No. PCT/GB2024/053121 filed on Dec. 13, 2024, which claims priority to United Kingdom Patent Application No. 2319305.5 filed on Dec. 15, 2023. Both of these applications are hereby incorporated by reference in their entirety.

### TECHNICAL FIELD

The present disclosure relates to navigation and determining the location of a device based on a signal of opportunity. In particular, the present disclosure relates to a method and system for navigation and determining the location of a device based on a signal of opportunity.

### BACKGROUND

The use of Global Navigation Satellite Systems (GNSS), for example, the Global Positioning System (GPS) has been well-established for determining the location of a device on the Earth. Such systems make use of a synchronized constellation of satellites in orbit of the Earth which broadcast their current position along with the time that the broadcast was made. Based on the amount of time that has elapsed between the signal from the satellite being broadcast and the signal being received at the device, the distance between the satellites and the device can be determined which allows a position of the device to be determined.

Because satellites in GNSS systems are used for navigation, they can be the target of spoofing or jamming which may cause a device to mis-calculate its current position.

Over recent years the prevalence of additional satellite constellations that may be used for other commercial purposes, such as communications, has increased. Examples of such constellations are Starlink and Iridium. While such satellites may broadcast timing information, this is not always the case. In addition, while there are publicly accessible databases online that provide a coarse position of such satellites, the exact position of a given satellite is not always known, since such satellites are not intended to be used for navigation.

Accordingly, there is a need for a method of utilizing the signals of non-navigation satellites as a back-up for calculating the position of a device when GPS and GNSS systems signals are unavailable.

In addition, there is a need for a method of determining a more precise location of non-navigation satellites and other sources of signals of opportunity.

### Known Methods of Determining Location

Current conventional methods of determining the location of a device are limited to using GNSS signals as signals of opportunity (SoO). For example, a GPS satellite periodically transmits a GPS message comprising the following information:
The time of transmission
The current precise position of the GPS satellite (i.e. the ephemeris)
The coarse position of GPS satellites in the constellation (i.e. the almanac)

Using the time of transmission, compared to the time the GPS message was received at device, the distance between the device and the GPS satellite can be determined. Then, using the ephemeris of the satellite, a locus of possible points that the device is located at can be determined. Specifically, the locus of points that are all a known distance away from the satellite is the surface of a sphere.

Receiving GPS messages from multiple different satellites allows multiple spheres to be defined. The intersection of these spheres limits the locus of points that the device could be at. With two signals, the locus is a circle, with three signals the locus is two points, and finally, with four signals, there is only one possible point that the device can be that satisfies the determined distances from each of the GPS satellites. If the altitude of the device is known, for example the device is on the surface of the Earth, then the position of the device can be determined from three GPS satellites alone. This process of identifying various intersecting loci of points is known as trilateration or multilateration.

Often with GNSS constellations, many more than 4 satellites are visible to the device at any given time. Where more than 4 GPS signals are received, these further signals can improve the accuracy of the determined position.

Ephemeris data is typically valid for a few hours, typically four hours, and provides the precise location from which the position of a GPS satellite can be determined. After four hours, if the ephemeris data is not updated, it will have degraded enough that any position determined using the ephemeris will not have sufficient accuracy.

Almanac data provides a coarse position of several, if not all, the GPS satellites in the constellation and is valid for up to two weeks. Typically, the almanac is not used for position determination but is instead used for a “warm start-up” where the device can approximately determine which satellites in the constellation are currently visible. This is done to speed up the start-up process and lock onto GPS signals faster.

United Kingdom patent GB2585087 discusses methods of using non-navigation signals to determine the location of the device. However, the methods described are limited to signals that still broadcast a time and are at a fixed location on the Earth or a geostationary orbit, where the position of the transmission location does not change.

In GB2585087 the signals used may be calibration timing signals for commercial radio-controlled clocks and timers on mobile phones. By synchronizing the timing signals from these various fixed sources, the missing pieces of information can be approximated and then the position of the device can be determined in a similar manner to that of GPS. Nonetheless, the methods in GB2585087 still require the SoO to contain timing information in order to work, and they are limited to sources with fixed locations that do not change.

### SUMMARY

The invention is defined by the independent claims, with further embodiments defined by the dependent claims.

In a first aspect of the invention there is provided a method for determining a position of a device, the method comprising: receiving, at the device, one or more signals of opportunity, wherein each signal of the one or more signals of opportunity originates from a different transmission source of a one or more transmission sources, and wherein at least one transmission source of the one or more transmission sources is a moving transmission source moving relative to the earth; determining an identity of each transmission source of the one or more transmission sources based on the respective signal of the one or more signals of opportunity; obtaining position data for each transmission source based on the identity of said transmission source; and determining the position of the device based on a respective property of each signal of the one or more signals of opportunity, and the position data for each of the one or more transmission sources.

The first aspect, therefore, provides a way of determining the location of a device using signals of opportunity coming from sources that may not conventionally be used in navigation.

In some embodiments, the device comprises an inertial measurement unit (IMU) and the position of the device is further determined based on data from the IMU.

In some embodiments, determining the position of the device comprises: determining a first distance from the device to at least one transmission source of the one or more transmission sources, based on the respective property of the signal of opportunity associated with the at least one transmission source; determining a first locus of points on which the device may be positioned based on the first distance and the position of the at least one transmission source; receiving, at the device an additional signal of opportunity at a later time from the at least one transmission source; obtaining second position data for the at least one transmission source based on the identity of the at least one transmission source; determining a second distance from the device to the at least one transmission source, based on the respective property of the additional signal of opportunity; determining a second locus of points on which the device may be positioned at the later time based on the second distance and the second position data; determining the position of the device based on the first locus of points, the second locus of points and the data from the IMU.

Accordingly, this provides a way of determining the position of a device using signals of opportunity and supplementing the determination of position with IMU data in order to reduce the number of signals of opportunity required and reducing noise in the calculation of the position.

In some embodiments, determining the position of the device based on the first locus of points, the second locus of points and the data from the IMU comprises: determining a movement vector of the device over a period of time from receiving the one or more signals of opportunity to receiving the additional signal of opportunity based on the IMU data; aligning the movement vector with the first locus of points and the second locus of points such that the movement vector begins on the first locus of points and ends on the second locus of points; determining the position of the device when the one or more signals of opportunity were received as the position on the first locus of points that the movement vector begins; and determining the position of the device at the later time as the position on the second locus of points that the movement vector ends.

Accordingly, this reduces the number of signals of opportunity that are required.

In some embodiments, the position of the device is further determined based on a previously known position of the device previously stored in the memory of the device.

In some embodiments, determining the position of the device comprises: determining a distance from the device to at least one transmission source of the one or more transmission sources, based on the respective property of the signal of opportunity associated with the at least one transmission source; determining a locus of points on which the device may be positioned based on the distance from the device to the at least one transmission source; and determining the position of the device based on the locus of points, data from the IMU and the previously known position.

Accordingly, this provides a way of determining the position of a device using signals of opportunity when conventional navigational methods are no longer available.

In some embodiments, determining the position of the device based on the locus of points, data from the IMU and the previously known position comprises combining the data from the IMU and the locus of points using either a Kalman filter or a complementary filter.

In some embodiments, at least one signal of the one or more signals of opportunity the property of the signal comprises timing information or a phase of the signal, wherein a phase of the signals is at least one of a code phase of the signal or the phase of a carrier wave of the signal.

Accordingly, this allows signals that are not conventionally used for navigation to be used in determining the location of a device.

In some embodiments, determining the position of the device comprises determining a change in phase of the signal of opportunity associated with at least one transmission source of the one or more transmission sources; and determining a position of the device based on the determined change in phase and the position of the at least one transmission source.

Accordingly, this allows the relative speed and movement between the device and the transmission source to be determined.

In some embodiments, determining a position of the device based on the determined change in phase and the position of the at least one transmission source comprises: determining a speed of the device relative to the at least one transmission source based on the change in phase of the signal of opportunity; combining the data from the IMU and the speed of the device to produce a velocity vector; adding the velocity vector to the previously known position to determine the position of the device.

Accordingly, this improves the accuracy of navigation using an IMU and last known position and also minimizes drift that may be present in the IMU data.

In some embodiments, combining the data from the IMU and the speed of the device comprises combining the data from the IMU and the speed of the device using at least one of a Kalman filter, a complementary filter or a weighted sum.

In some embodiments, the one or more transmission sources is one moving transmission source and the one or more signals of opportunity is one signal of opportunity associated with the moving transmission source.

In some embodiments, the signal of opportunity associated with the at least one transmission source does not contain position data for the moving transmission source.

In some embodiments, determining the position of the device comprises trilateration or multilateration.

Accordingly, this allows the position of a device to be determined using three signals of opportunity.

In some embodiments, obtaining position data for each transmission source comprises identifying, from at least one signal of the one or more signals of opportunity, position data of the respective transmission source of said at least one signal.

Accordingly, this allows a combination of conventional navigation signals to be used in conjunction with other signals of opportunity not typically used for navigation.

In some embodiments, obtaining position data for each transmission source comprises, looking up the identity associated with the moving transmission source in a data source and retrieving the position of the transmission source from the data source.

Accordingly, this allows signals of opportunity to be used which do not contain position data of their respective transmission sources such as signals of opportunity not typically used for navigation.

In some embodiments, the data source is a database comprising position data for the moving transmission source.

In some embodiments, the database is located either: (a) on a memory stored on the device; or (b) on a public or private network with which the device is in communication.

In some embodiments, the moving transmission source a Low Earth Orbit (LEO) satellite.

In some embodiments, the data source includes orbital data and obtaining position data for each transmission source comprises determining the orbit of the moving transmission source and the location of the transmission source along that orbit when the respective signal was transmitted.

Accordingly, this means that the position of the transmission source can be calculated based on previously determined data, and the data source does not need to have live data.

In a second aspect of the invention there is provided a method for determining the location of a transmission source of a signal of opportunity, the method comprising: receiving, at one or more known locations, the signal of opportunity; measuring a property of the signal received at the one or more known locations; and determining a position data of the transmission source based on the measured property, wherein the position data comprises a location of the transmission source.

The second aspect, therefore, provides a way of determining the position of a transmission source such that their signals can be used for further navigation.

In some embodiments, the property of the signal comprises a time that the signal was transmitted from the transmission source and determining the position data of the transmission source comprises determining the difference between when the signal was transmitted from the transmission source and received at the one or more known locations.

In some embodiment, the method further comprises saving the position data in a database, wherein the database is saved on a device at any of the one or more locations or is located on a public or private network that devices can access for navigation.

Accordingly, this allows other devices to access the position data in order to navigate based on signals of opportunity from the transmission source.

In some embodiments, the property of the signal comprises a phase of the signal as received at each of the one or more known locations, wherein a phase of the signals is at least one of a code phase of the signal or the phase of a carrier wave of the signal.

Accordingly, the position of transmission sources that are not typically used for navigation can be determined.

In some embodiments, determining position data of the transmission source comprises: determining a change in phase of the signal of opportunity as received at the one or more locations; and determining the position data of the transmission source based on the determined change in phase and one or more known locations.

Accordingly, this allows the direction of travel of the transmission source relative to each known location to be determined.

In some embodiments, providing the position data of the transmission source to a device and; determining, based on the location of the transmission source and a property of the signal as received at the one or more known locations, the location of the device.

In some embodiments, the transmission source is one of: a satellite in orbit of the Earth, an aircraft in flight, a moving vehicle, a radio time transmission source, a communication signal transmission source, a television signal transmission source, an ad-hoc transmitter, a navigational aid or a non to directional beacon.

In some embodiments, the position data further comprises a trajectory or a set of orbital parameters of the transmission source, wherein the trajectory or the set of orbital parameters enable the location of the transmission source at a later time to be calculated or predicted.

In some embodiments, the method further comprises: determining a velocity of the transmission source relative to at least one of the one or more known locations; and determining, based on the velocity of the transmission source and the location of the transmission source, the trajectory or the set or orbital parameters of the transmission source.

In some embodiments of the second aspect, the location of the transmission source is determined using trilateration or multilateration.

In some embodiments, the one or more locations comprises three or more locations.

Accordingly, this means that the position of the transmission source may be determined based on just the signal as it is received at each of the known locations.

In some embodiments of the second aspect, determining the position data is further based on an approximate position data of the transmission source, wherein the approximate position data is any one of a previous position data of the transmission source that has since degraded or position data of the transmission source that has been retrieved from a database.

Accordingly, this reduces the number of known positions required to determine the location of the transmission source.

In a further aspect of the invention, there is provided method of determining the location of a device comprising: determining the location of the device using signals from satellites that are part of a Global Navigation Satellite System (GNSS); determining the location of a transmission source of a signal of opportunity that is not part of the GNSS using the method of the second aspect; in response to the device no longer receiving signals from satellites that are part of the GNSS, determining the position of the device based on the signal of opportunity and the location of the transmission source.

Throughout this application, unless stated otherwise, transmission source and signal source are used interchangeably. Similarly, position and location are used interchangeably.

### BRIEF DESCRIPTION OF THE DRAWINGS

FIG. 1 shows a constellation of satellites in orbit and visible to a device.

FIG. 2 shows an exemplary device that can be used in accordance with the invention.

FIG. 3 shows a method for determining the location of a device using a signal of opportunity in accordance with a first aspect of the invention.

FIG. 4 shows an exemplary application of the method of FIG. 3 of a device navigating in conjunction with an Inertial Measurement Unit (IMU).

FIG. 5 shows an exemplary scenario of navigating with an IMU when the initial position of a device is not known.

FIG. 6 shows an exemplary method of determining the position of a device as a part of the method of FIG. 3.

FIG. 7 shows a further exemplary method of determining the position of a device as a part of the method of FIG. 3.

FIG. 8 shows a method for determining the location of a satellite in accordance with a second aspect of the invention.

### DETAILED DESCRIPTION

### System Geometry

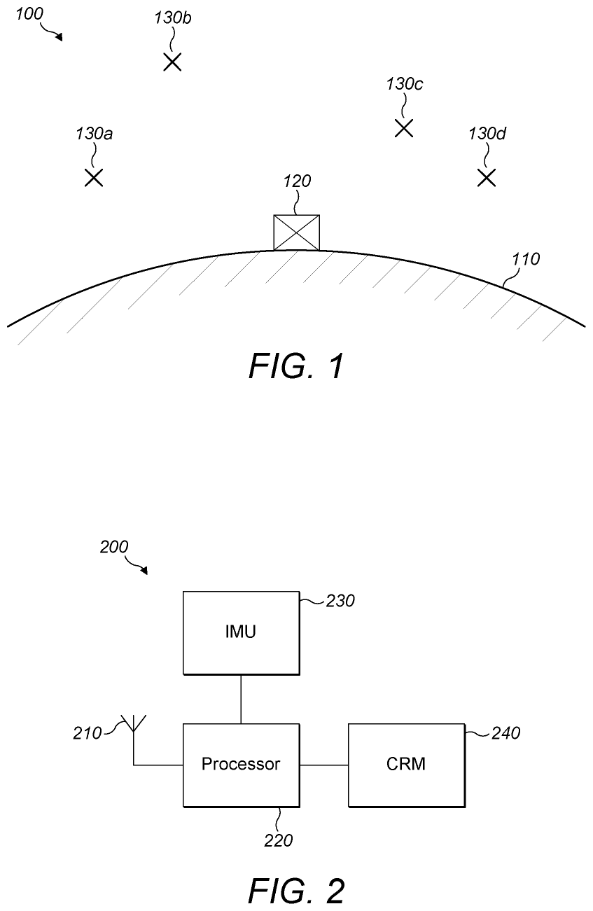

FIG. 1 shows an exemplary system 100 according to the invention in use. A device 120 is in a position relative to the Earth 110. At different positions around the device 120 are multiple sources 130a-130d of signals of opportunity (SoO).

While FIG. 1 shows device 120 on the surface of the Earth 110, it will be appreciated that the device can be in the air (such as mounted on an aircraft) or a satellite in orbit at an unknown location.

A signal of opportunity is any external signal that can be received at the device 120 and used in determining the location of the device. For example, in conventional GNSS systems, the signals of opportunity will be broadcast from satellites (such as GPS satellites) and contain position, navigation and timing information. Alternatively, the SoO can be a signal broadcast from a ground station, a mobile vehicle or some other satellite that is not intended to be used for navigation purposes such as Low Earth Orbit (LEO) satellites. Where a SoO is not intended to be used for navigation purposes, other properties of the signal can be used, which will be discussed in more detail below.

While the source of a SoO may be fixed, more commonly the source is moving relative to the surface of the Earth and the present invention is applicable to both fixed and moving signal sources.

### System Description

FIG. 2 shows an exemplary device 200 on which the methods described herein can be performed. Device 200 is configured to receive signals of opportunity and is similar to device 120 discussed above in connection with FIG. 1. Device 200 comprises an antenna 210 that is capable of receiving electromagnetic signals such as radio frequency (RF) signals. Antenna 210 may be a standard communications antenna capable of receiving signals broadcast from satellites or other sources of SoOs. Alternatively, antenna 210 may be a multi-element antenna, such as a controlled reception pattern antenna. Multi-element antennas are capable of receiving a SoO at each of the antenna elements. Due to the spatial separation between each of the antenna elements, it is then possible to determine the direction that a signal is being received from.

Device 200 further comprises a processor 220 in communication with the antenna. Processor 220 may be capable of processing the SoOs received at antenna 210. Examples of a processor include a Central Processing Unit (CPU), Graphics Processing Unit (GPU), Field Programmable Gate Array (FPGA), Application Specific Integrated Circuits (ASIC) or sequential or combinational logic.

Optionally, device 200 may further comprise an inertial measurement unit (IMU) 230 that is in communication with the processor. The IMU 230 is capable of providing telemetry data for the device. Such telemetry data can be from accelerometers, gyroscopes, compasses, altimeters, and other motion detection sensors to provide movement, direction and acceleration data to the processor for use in the methods described herein.

Device 200 may also comprise a computer-readable medium 240 storing instructions that, when executed by the processor 200, cause the processor to perform any of the methods described herein.

The computer-readable medium may be internal storage media or may include removable or non-removable storage media. Examples of storage media 145 technologies include: semiconductor memory, such as Random Access Memory (RAM), Read Only Memory (ROM), flash memory, solid-state drives (SSD); magnetic storage media, such as magnetic disks; and optical storage, hard disk drives (HDD) and CD, CD-ROM, DVD and BD-ROM.

It will also be appreciated that, in place of antenna 210, synthetic or pre-recorded SoOs may be stored on the computer-readable medium 240 for the processor to process offline or after device 200 has been used in the field. Similarly, in place of IMU 230, synthetic or pre-recorded telemetry data may also be stored on computer-readable medium 240.

### Non-Navigation Signal Sources

The methods described herein are not limited to SoO that come from GNSS satellites such as those discussed in the background. However, signals that are not intended to be used for navigation, such as those that are not from GNSS satellites often do not contain all the information required to determine the position of a device. For example, the SoO may not contain any equivalent of an ephemeris or other suitable position data from which the location of a device can be determined, nor may there be any transmission time in the signal.

The methods described herein are not limited to fixed sources of SoO and can be any source that is transmitting either a periodic signal, which may be a signal with a repeating known structure, or timing information. Preferably the sources are satellites in orbit such as Low Earth Orbit (LEO) satellites, but the sources can also be ground stations, or coming from vehicles such as cars and aircraft.

Examples of possible signals are communication signals, radio time signals, television signals, radio signals, ad-hoc signals, navigational aids, and non-directional beacons.

Radio time signals are typically, but not exclusively, broadcast on the VLF and LF radio bands (e.g. 3 to 300 kHz) and have reasonably predictable radio propagation characteristics, resulting in low uncertainty in the received time signals. Because of their relatively long wavelength, these radio time signals tend to diffract over geological obstacles such as mountain ranges and follow the contour of the Earth. This means that radio time signals are receivable over very large areas, often overlapping with other radio time signals.

Navigational aids include airport directional signals.

Ad-hoc signals are signals from ad-hoc transmitters configured to re-transmit a weak signal of opportunity (at the same or a different frequency) or to transmit an original signal from a different transmission source. The ad-hoc transmitter can be deployed in environments where signals of opportunity are sparse or weak in order to provide further coverage of a particular area and increase the accuracy of the positioning system and method. Moreover, the signals broadcast by the ad-hoc transmitters may be the only signals that are used by the device 200 to determine its position.

Non-directional beacons are signals from typically ground-based radio transmitters used to aid and navigate vessels in aviation and marine applications during their approach.

### Determining Location Using Non-Navigation Signal Sources

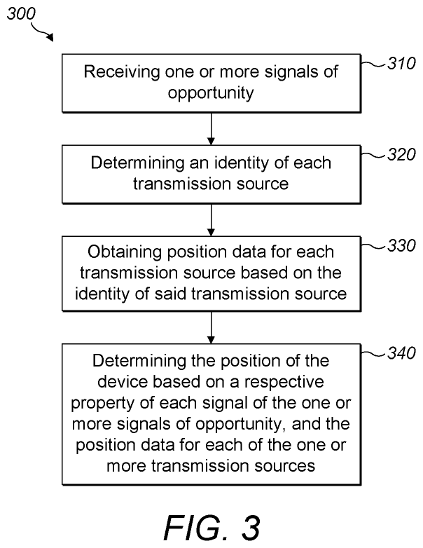

In the first aspect of the invention, there is provided a method for determining the location of a device using SoO. FIG. 3 outlines a method 300 for determining the location of a device, for example, device 200. The method begins with step 310, which comprises receiving, at the device, a plurality of signals of opportunity, wherein each signal of the plurality of signals of opportunity originates from a different transmission source. As outlined above, the SoO may be from any number of sources such as GNSS satellites, LEO satellites or other vehicles. The transmission sources do not need to be in a fixed location relative to the device.

At least one transmission source of the one or more transmission sources is a moving transmission source moving relative to the earth. However, it will be appreciated by the skilled person that the methods disclosed herein, are equally applicable in scenarios where some or all of the transmission sources are at a fixed location relative to the Earth, such as being on the ground or geostationary.

In some examples of the invention, which will be explained in more detail below, it is only necessary to have one transmission source and its associated signal of opportunity. Because the invention is not limited to using navigation signals such as signals from GNSS satellites, some or all of the signals of opportunity may not contain position data for the transmission sources associated with that signal of opportunity.

In step 320, the identity of each of the transmission sources is determined based on the respective SoO received at the device. The identification may be based on information content of the signal, such as an ID packet included in the digital information that identifies the signal source, or a feature of the modulation pattern, as is common in GPS satellites.

In step 330, based on the identity of the transmission source, position data for the transmission source can be obtained. As discussed above, for SoO that are not intended for use with navigation systems, there is no position content within the SoO. Therefore, it is necessary to obtain the position of the transmission source from a separate means. The device may have access to a data source such as a database stored in internal memory that contains position information indexed by the identity of the source. For example, the device may identify a given transmission source as a specific satellite from the Iridium constellation. The database stored in the device may contain orbital data, analogous to an ephemeris of a GPS satellite, for the specific Iridium satellite that can then be used in later steps of method 300. For other transmission sources that are not satellites such are cars or aircraft, other trajectory data may be used such as last known location, speed, acceleration and heading, or data regarding a fixed circuit that the transmission source might be taking, such as a car driving around a track.

Alternatively, the device may access the database that is in communication with the device through a network which may be a public or private network. An example of a database that contains satellite orbits can be found at space-track. org. A database of transmission source position data may also be generated by methods described in the second aspect of the invention outlined below.

Obtaining position data for each transmission source may comprise looking up the identity associated with the moving transmission source in a data source and retrieving the position of the transmission source from the data source. The data source may be any of the databases discussed herein.

Where the transmission source is a satellite such as a GNSS satellite or a LEO satellite, the data source may include orbital data and obtaining position data for such transmission sources may comprise determining the orbit of the transmission source and the location of the transmission source along that orbit when the respective signal was transmitted.

Because the methods described herein may still use signals from GNSS satellites, position data of a given transmission source may also be obtained from the associated signal of opportunity should said signal of opportunity contain such data. However, it will be appreciated that obtaining position data from the signal itself, for example an ephemeris, does not require the identity of the transmission source to be determined since all the necessary information is within the SoO and the identity does not need to be looked up in a separate data source.

In step 340, based on a respective property of each signal and the obtained position of the respective transmission source, the location of the device is then determined. The property of the signal may be the phase of the signal or timing information if there is any present in the signal, or some other property of the signal that allows the distance to the transmission source or movement relative to the movement relative to the transmission source to be determined. If the distance to the transmission source can be determined, then the position of the device can be determined in a manner similar to that of conventional GNSS systems such as through trilateration or multilateration.

If timing information is a property of the signal that is used, and the timing information is not synchronized between several transmission sources, then it will be necessary to determine the offsets between the timing signals. Such offsets can be determined and applied using the methods outlined in United Kingdom patent GB2585087. The timing signal can be used to determine the distance from the device to the transmission source in a similar manner to GPS signals as discussed above, from which the position of device 200 can be determined.

Where the phase of a signal is the property of the signal that is used, this is not limited to just the analogue phase of the signal such as the phase of the carrier wave. Instead, the code phase being transmitted can be used. Most satellites, including GNSS satellites, will broadcast periodic packets of information that will be encoded in some repetitive manner (i.e. a code). The distance covered by the signal in the time it takes to broadcast the code is known as the code length. The proportion of the code that has been broadcast at a given time is known as the code phase. Put differently, if the code is known exactly, and it is known that the code is sent at known intervals (for example, once per second starting at a known time), then the time that a specific part of the code is received at the device can be used to determine the phase of the code in an analogous manner to the phase of a sinusoidal signal. Alternatively, a relative code phase can be determined by sampling the point in the code that is received at periodic intervals. For example, measuring how many bits into the code the signal is every second. As the device and the transmission source move, this relative code phase will change. It will be appreciated that code phase and code length can be used in a similar manner to the wavelength and phase of an analogue signal in the present invention and any reference to phase can mean either the phase of an analogue signal or the code phase unless stated otherwise.

It will be appreciated that different properties of different signals can be used to determine position. For example, for some signals received by device 200, the timing signals can be used, and for other signals received by device 200, the phase of the signal can be used for the same position calculation. Additionally, both the timing and phase of a single signal may be used to provide a better estimate of the distance between the device 200 and the source of said signal.

Depending on the additional information that is available to the device, such as IMU data or previous known position, the minimum number of SoO needed will vary.

### Navigation Based Solely on Signals of Opportunity

Where the device has no information as to its location and is relying solely on SoO, typically at least four SoO are required. As with GNSS systems, if it is known the device is on the ground or at a specific altitude then only three are required.

When using the phase of a SoO, it is only possible to measure in fractions of a wavelength, since phase is inherently periodic, this phenomenon is known as phase ambiguity. This means that a source that is, for example, 1.5 wavelengths away will appear the same as a signal that is 3.5 wavelengths away. Therefore, preferably the wavelength (or code length) of the SoO should be as long as possible to minimize this phase ambiguity. The carrier signal will often have a much shorter period than the period of the transmission codes in the SoO. In the case of signals from GNSS satellites, code length, that is, the distance the signal travels in the time it takes to transmit a full cycle of the code, will be comparable to that of distance from the source to the Earth. However, for other transmission sources, the signals are not designed to have their phase (for example, analogue or code phase) analyzed for navigation purposes and so may have a much shorter wavelength/code length. Some of this ambiguity can be resolved by the geometry of transmission sources with respect to the device.

Referring back to FIG. 1, in an exemplary scenario of method 300, device 120 measures the following phases of the satellites 130a to 130d to be 0.1, 0.5, 0.7 and 0.9 code lengths respectively. Due to the phase ambiguity of each individual signal, it is not possible to determine from a single signal how many whole code lengths away the satellites are. Effectively, there are 5 unknowns in the situations, a, b, c and d, which is an integer number of code lengths for their respective satellites, and e, the position of device 120. A system of equations can be set up of the form:

(a+0.1)λ=|position of 130a-e|

(b+0.5)λ=|position of 130b-e|

(c+0.7)λ=|position of 130c-e|

(d+0.9)λ=|position of 130d-e|

Where λ is the code length of the signal. It will be appreciated by the skilled person that the code length (or wavelength) of each signal does not need to be the same and the corresponding known code length of each signal can be substituted into the equations above. While this is a system of 4 equations with 5 unknowns, the fact that a-d are integers, and the positions of the transmission sources are known from step 340 of method 300, the position can be determined in an iterative manner. It will be appreciated that a similar system of equations can be set up using the wavelengths of a signal, and a mixture of wavelengths/phase and code lengths/code phase can be used depending on the signals available to the device 200.

As an alternative, the phase ambiguity can be resolved if a previously known position of the device is available. Based on the assumption that the device is near the previously known position, an approximate distance between the device and the satellite can be determined as the distance between the previously known position and the position of the transmission source. Then, by finding the whole number of code lengths plus the code phase that is closest to this approximate distance, the actual distance can be determined. For example, if the approximate distance calculated from the previously known position is 3.9 code lengths, and the measured code phase is 0.1 code lengths, it is most likely that the device is now 4.1 code lengths away from the transmission source. It will be appreciated that further movement data such as IMU data can also be used to supplement this calculation by providing the direction and distance that the device has moved between the previously known position and the current time. Again, it will be appreciated that similar methods can also be applied to using the wavelengths and phase of the signal such as the carrier signal.

In this example, four SoO are be used, and this is the worst-case scenario when no further information is available. However, as mentioned above three SoO could be used if the altitude of the device 200 is known. Additionally, more than four SoO can be used. The more SoO that are available for the position determination, the less susceptible the determined location of device 200 is to noise or any errors in the signal. Fewer SoO are also necessary if there is additional information available to device 200 on which to make a calculation.

### Navigation in Conjunction With an IMU

The more common scenario is that device 200 is initially navigating using GNSS signals which then drop out, for example, because the GNSS signals are being spoofed or jammed and the device has identified such signals as unreliable. In such a scenario, device 200 will have a last known position, and device 200 can determine its current position based on its last known position.

Using IMU 230 outlined previously, the relative movement of the device between the time the last known position was recorded, and the present time can be determined. Based on the recorded movement in that period, an approximate new position can be determined, typically by adding the movement vector to the last known position. However, relative position and motion measured using accelerometers and gyroscopes, which are commonly used in IMUs such as IMU 230, exhibit drift over time which causes the new position to become less accurate the longer device 200 is unable to make use of GNSS signals. Even though GNSS signals are not available, other SoO can still be used to minimize the loss of accuracy over time.

In a further exemplary scenario of method 300, steps 310 to 330 are carried out as described above for one or more SoO and their signal phases or timing signals. Since the IMU is also being used in conjunction with a last known position, even just one SoO can be used to improve the calculation for the new position.

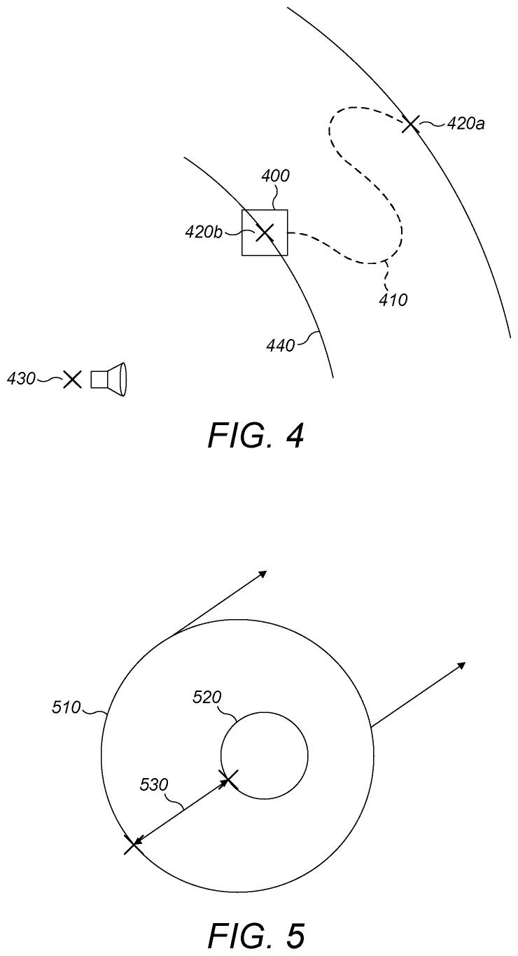

FIG. 4 shows a bird-eye view of device 400, which is similar to device 200, travelling along a path 410. At time t₁ the position of the device 420a is known but device 400 subsequently loses access to GNSS signals but is still receiving an SoO from transmission source 430 that is not a navigation signal. At time t₂, device 400 has continued along path 410 to unknown position 420b. Using method 300, device 400 is able to determine a locus of points at time t₂ that device 400 could be located based on the SoO. It will be appreciated that this locus of points 440 will be a sphere centered on the transmission source 430 (shown as a segment of a circle in FIG. 4). From an IMU onboard device 400, the vector the device travelled from position 420a to 420b can be determined. However, as mentioned previously, there may be an error in this calculation due to drift which will accumulate over time.

It will be appreciated that the locations on the locus of points 440 that are closer to the last known location 420 a are more likely to be the location of 420b than those points that are further away. Nonetheless, as more time passes since the last known position 420a was determined, the less valid this assumption will be. Furthermore, there will only be a small set of locations on the locus of points 440 that are compatible with the vector received from the IMU and the previously known position. Therefore, by combining the locus of points 440, with the IMU data and the last known position 420a, position 420b can be determined. These data points may be combined using various methods such as complementary filters or a Kalman filter. This allows a more accurate position to be determined since the relatively low noise in the IMU can be used to compensate for the noise in the locus of points 440, and the direct calculation of positions from the locus of points 440 (as opposed to the double integration of acceleration used by IMUs) can be used to compensate for the drift in the IMU. This process can then be repeated for further time steps using either location 420a or 420b to allow device 400 to reliably navigate without GNSS for longer.

It will be appreciated that if initial position 420a is not known it would still be possible to determine the position of device 400 at timestep t₂. Using the SoO, two loci of points can be determined, one at timestep t₁ and another at timestep t₂. Because the IMU provides a vector, i.e. a direction of travel and the distance of travel from one locus of points to another, by fitting the vector to the two spheres, the location of device 400 at both timesteps can be determined.

To better explain the fitting process, FIG. 5 shows two loci of points 510, and 520. There is clearly only one location where vector 530 can traverse from one locus to the other.

Returning to FIG. 4, alternatively, rather than explicitly determining a locus of points 440 from the transmission source at each time step, the change in phase of the SoO (i.e. the code phase or carrier signal phase) can be determined between one time step and the next to provide additional velocity/movement data to complement the IMU's data. This velocity/movement data can be combined with the previously known location and IMU data using a complementary filter or Kalman filter as discussed above.

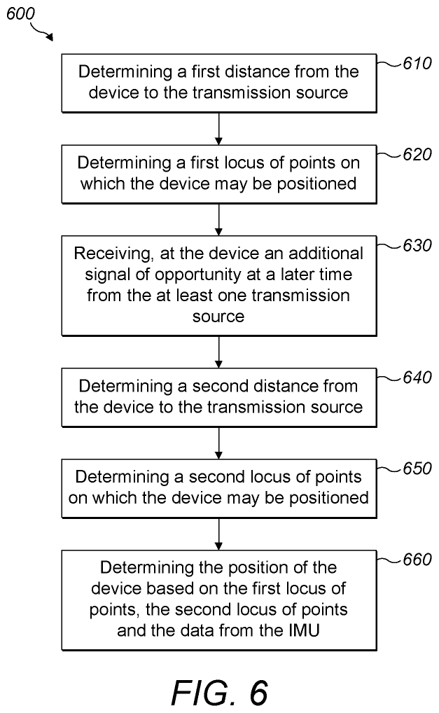

FIG. 6 shows a further method 600 of determining the position of the device based on a respective property of each signal of the one or more signals of opportunity, and the position data for each of the one or more transmission sources. This method is an example of step 340 of method 300 when data from an IMU is available and only one transmission source is necessary, although it will be appreciated that signals from further transmission sources can be used. To begin method 600 a signal of opportunity has been received and the position data for the transmission source has been determined.

Method 600 begins with step 610, determining a first distance from the device to the transmission source, based on the respective property of the signal of opportunity. This distance can be determined using timing information or phase information as discussed above.

In step 620, a first locus of points on which the device may be positioned based on the first distance and the position of the transmission source is determined. It will be appreciated that when only one transmission source is available, this locus of points will be a sphere as discussed previously. If more than one transmission source and their associated SoO are used, this locus of points may be more specific, such as a circle in the case of two transmission sources, or discrete points in the case of three or more transmission sources.

In step 630, a second signal of opportunity is received from the transmission source. This second signal of opportunity is received at a later time when the device or the transmission source may have moved relative either to each other or the Earth. Since the SoO may be a continuous signal, the second SoO may simply be a sample of the same SoO used to determine the first locus of points at a later time rather than a completely separate signal.

In step 640, second position data for the at least one transmission source based on the identity of the at least one transmission source is determined. This may be done in the same manner as step 610.

In step 650, a second locus of points on which the device may be positioned at the later time based on the second distance and the second position data is determined. This may be done in the same manner as step 620.

In step 660, the position of the device is determined based on the first and second locus of points and data from the IMU. In particular, as discussed above in connection with FIG. 5, by fitting a movement vector to the two loci of points, there is only one possible arrangement that is compatible with all three pieces of data. A movement vector, indicating the movement of the device from when the SoO was received to when the second SoO was received, can be determined from the IMU data. Once the movement vector has been fit to the two loci of points, with the vector starting on the first locus and ending on the second locus, where the vector intersects with each locus will be the position of the device at the respective times the corresponding SoO were received.

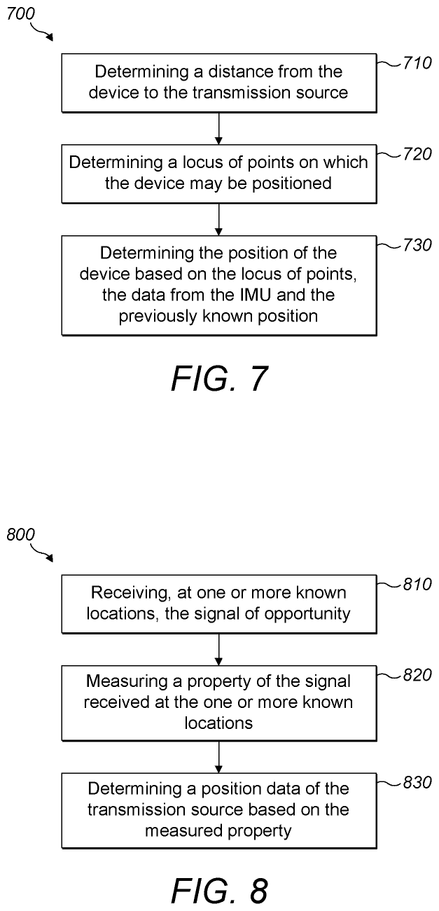

FIG. 7 shows a further method 700 of determining the position of the device based on a respective property of each signal of the one or more signals of opportunity, and the position data for each of the one or more transmission sources. This method is another example of step 340 of method 300 when data from an IMU is available, along with a previously known position and only one transmission source is necessary, although it will be appreciated that signals from further transmission sources can be used. To begin method 700 a signal of opportunity has been received and the position data for the transmission source has been determined.

Method 700 begins with step 710, determining a distance from the device to the transmission source, based on the property of the signal of opportunity. In step 720, a locus of points on which the device may be positioned based on the distance from the device to the transmission source is determined. Steps 710 and 720 may be performed in the same manner as steps 610 and 620 of method 600.

In step 730, the position of the device is determined based on the locus of points, data from the IMU and the previously known position. For example, data from the IMU and the locus of points may be combined using either a Kalman filter or a complementary filter. Data from the IMU may be used to determine a movement vector from the previously known position to the time when the signal of opportunity was received. By adding the movement vector to the previously known position, an estimate of the position of the device can be determined. By considering the point on the locus of points that is closest to this estimate of the position of the device, the position of the device can then be determined.

In a further example of step 340 of method 300, when the IMU is available, a change in phase or Doppler shift in one signal of opportunity can be determined. Based on this change in phase or Doppler shift, a speed of the device relative to the transmission source associated with the signal of opportunity can be determined. This speed can then be combined with the data from the IMU using either a Kalman filter or complementary filter, or a weighted sum to provide more accurate motion information from which the position of the device can be determined, either by combining it with the previously known position, or from data from other signals of opportunity using methods described above.

### Determining Location of Non-Navigation Signal Sources

As outlined in the discussion of the first aspect of the invention, step 330 of method 300 comprises obtaining position data for each transmission source based on the identity of said transmission source. While public resources such as space-track. org are available and can be used in exemplary embodiments of method 300, data may be incomplete or not precise enough for the needs of device 200.

Therefore, in a second aspect of the invention, there is provided a method of determining the position of a transmission source of a signal of opportunity.

FIG. 8 outlines a method 800 for determining the position of a transmission source of a SoO.

The method begins with step 810, which comprises receiving, at one or more known locations, a signal of opportunity. As outlined above, the SoO may be from any number of sources such as GNSS satellites, LEO satellites or other vehicles. While there is often little need to perform this method on signals from GNSS satellites, method 800 could still be used as an alternative to the common laser range-finding techniques that are used to correct errors in ephemeris and almanac data. The transmission sources do not need to be in a fixed location relative to the receiver at each of the one or more known locations.

In step 820, a property of the signal as received at the one or more known locations is measured. The property of the signal may be the phase of the signal or timing information if there is any present in the signal, or some other property of the signal that allows the distance to the transmission source to be determined.

As discussed above in connection with method 300, if timing information is used, and the timing information is not synchronized between several transmission sources, then it will be necessary to determine the offsets between the timing signals of the transmission source and in this case, the receivers at each of the known locations.

Similarly, as discussed above, in connection with method 300, where the phase of a signal is used, this is not limited to just the analogue phase of the signal such as the phase of the carrier wave, for example, the phase can also refer to the code phase.

In step 830, position data of the transmission source based on the measured property is determined. The position data comprises at least the location of the transmission source, but may also include additional data such as velocity, trajectory, orbital parameters etc. As discussed previously, at each known location it will be possible to determine a distance from the known location to the transmission source, providing a locus of possible points that the transmission source could be located (i.e. a sphere). With each known location receiving the SoO, this locus of points can be reduced until a single point remains.

Method 800 can be performed using a device 200 located at each of the known locations. It will be appreciated by the skilled person that since the position of the device is known when performing this method, it is not necessary that device 200 has an IMU 230. It will also be appreciated that each device 200 at each of the known locations will need to communicate with one another or communicate their data to a central location so that the position data of the transmission source can be determined. This communication can be done either using antenna 210, a wired connection or some other form of network communication known in the art.

The position data determined in step 830 may then be stored in CRM 240 on a least one of the devices 200 at the known locations for later use, for example, to be used in step 330 of method 300. Alternatively, the position data may be stored remotely and accessible via a communications network, such as on a server.

If the transmission source is a satellite, such as a LEO satellite, the position data can include orbital parameters that are equivalent to the ephemeris of a GPS signal. To determine the orbital parameters, it may be necessary to receive the SoO at each of the at least one known location at multiple time steps in order to have enough data to determine velocity and acceleration. For example, by measuring the change of phase of the SoO over time, the transmission source's velocity/movement can be determined.

When determining the position data, the approximate position of the transmission source known from other databases or from previous position data that has since degraded, can be used to reduce the number of known locations required. For example, with just one known location there is a sphere of points where transmission source of the SoO can be positioned. Using the approximate location of the transmission source from other databases or from the previous position data that has since degraded, the closest point on the sphere of points can be determined as the position of the transmission source.

The determined position data of the transmission source may be stored or saved on a device or may be uploaded to a public or private network. This allows other devices to access the data and use the position data for their own navigation purposes. For example, the position data may be stored on a database accessible via the internet such as a website, or other devices may directly communicate with the device that has the position data stored on it such as through radio communications.

In general, the principles used to determine the location of the device 200 in the first aspect of the invention can also be applied when determining the location of the transmission source in the second aspect. For example, the equations related to resolving phase ambiguity can also be applied to the second aspect except rather than multiple signals being received at one location, the same signal is received at multiple locations. Similarly, any knowledge of the approximate position of the transmission source can also be used to resolve the phase ambiguity and reduce the number of known locations required.

Because satellites follow a predictable path in their orbit, the position data for satellites determined using method 800 can be valid for a period of time. Therefore, it is not necessary to have methods 300 and 800 operating in tandem.

Nonetheless, method 800 can be used simultaneously with method 300. In particular, one or more devices similar to device 200 may be set up at known locations in the field, hereafter referred to as device group A. An additional set of devices, such as device 200 mounted to a vehicle, may be trying to navigate in the area, hereafter referred to as device group B. Since the devices in group A are not moving, their positions are always known, and they can repeatedly carry out method 800 to determine the position of several transmission sources. By communicating these positions to device group B, device group B can then use these transmission source positions to determine the locations of each device in device group B in line with method 300. As will be appreciated from the discussion of each of these methods, only one device is required in each device group.

As an alternative application of the methods described herein, both methods may be carried out on a single device. A device 200 mounted to a vehicle can be used to navigate using conventional GNSS methods, while using conventional GNSS methods, the vehicle's position will be known. While the vehicle's position is known, it can also be carrying out method 800 on additional sources of SoO such as LEO satellites that are not typically used for navigation. Because the orbital data collected from method 800 can be valid for a period of time, should the GNSS signals no longer be available, device 200 will already have access to the orbital data for alternative transmission sources, and so will be able to transition to performing method 300.

### EXAMPLES

The following is a non-exhaustive list of embodiments of the invention according to the first and second aspects.
1. A method for determining a position of a device, the method comprising:
receiving, at the device, one or more signals of opportunity, wherein each signal of the one or more signals of opportunity originates from a different transmission source of a one or more transmission sources, and wherein at least one transmission source of the one or more transmission sources is a moving transmission source moving relative to the earth;
determining an identity of each transmission source of the one or more transmission sources based on the respective signal of the one or more signals of opportunity;
obtaining position data for each transmission source based on the identity of said transmission source; and
determining the position of the device based on a respective property of each signal of the one or more signals of opportunity, and the position data for each of the one or more transmission sources.
2. The method of example 1, wherein the device comprises an inertial measurement unit (IMU) and the position of the device is further determined based on data from the IMU.
3. The method of example 2, wherein determining the position of the device comprises:
determining a first distance from the device to at least one transmission source of the one or more transmission sources, based on the respective property of the signal of opportunity associated with the at least one transmission source;
determining a first locus of points on which the device may be positioned based on the first distance and the position of the at least one transmission source;
receiving, at the device an additional signal of opportunity at a later time from the at least one transmission source;
obtaining second position data for the at least one transmission source based on the identity of the at least one transmission source;
determining a second distance from the device to the at least one transmission source, based on the respective property of the additional signal of opportunity;
determining a second locus of points on which the device may be positioned at the later time based on the second distance and the second position data;
determining the position of the device based on the first locus of points, the second locus of points and the data from the IMU.
4. The method of example 3 wherein determining the position of the device based on the first locus of points, the second locus of points and the data from the IMU comprises:
determining a movement vector of the device over a period of time from receiving the one or more signals of opportunity to receiving the additional signal of opportunity based on the IMU data;
aligning the movement vector with the first locus of points and the second locus of points such that the movement vector begins on the first locus of points and ends on the second locus of points;
determining the position of the device when the one or more signals of opportunity were received as the position on the first locus of points that the movement vector begins; and
determining the position of the device at the later time as the position on the second locus of points that the movement vector ends.
5. The method of any preceding example, wherein the position of the device is further determined based on a previously known position of the device previously stored in the memory of the device.
6. The method of example 5 when dependent on example 2, wherein determining the position of the device comprises:
determining a distance from the device to at least one transmission source of the one or more transmission sources, based on the respective property of the signal of opportunity associated with the at least one transmission source;
determining a locus of points on which the device may be positioned based on the distance from the device to the at least one transmission source;
determining the position of the device based on the locus of points, data from the IMU and the previously known position.
7. The method of example 6 wherein determining the position of the device based on the locus of points, data from the IMU and the previously known position comprises combining the data from the IMU and the locus of points using either a Kalman filter or a complementary filter.
8. The method of any preceding example wherein for at least one signal of the one or more signals of opportunity the property of the signal comprises timing information.
9. The method of any preceding example wherein for at least one signal of the one or more signals of opportunity, the property of the signal comprises a phase of the signal.
10. The method of example 9 wherein a phase of the signals is at least one of a code phase of the signal or the phase of a carrier wave of the signal.
11. The method of example 9 or example 10, wherein determining the position of the device comprises:
determining a change in phase of the signal of opportunity associated with at least one transmission source of the one or more transmission sources; and
determining a position of the device based on the determined change in phase and the position of the at least one transmission source.
12. The method of example 11 when dependent on examples 2 and 5 wherein determining a position of the device based on the determined change in phase and the position of the at least one transmission source comprises:
determining a speed of the device relative to the at least one transmission source based on the change in phase of the signal of opportunity;
combining the data from the IMU and the speed of the device to produce a velocity vector; adding the velocity vector to the previously known position to determine the position of the device.
13. The method of example 12 wherein combining the data from the IMU and the speed of the device comprises combining the data from the IMU and the speed of the device using at least one of a Kalman filter, a complementary filter or a weighted sum.
14. The method of any one of examples 2 to 13 when dependent on example 2 wherein the one or more transmission sources is one moving transmission source and the one or more signals of opportunity is one signal of opportunity associated with the moving transmission source.
15. The method of any preceding example wherein the signal of opportunity associated with the at least one transmission source does not contain position data for the moving transmission source.
16. The method of any preceding example, wherein determining the position of the device comprises trilateration or multilateration.
17. The method of any preceding example, wherein obtaining position data for each transmission source comprises identifying, from at least one signal of the one or more signals of opportunity, position data of the respective transmission source of said at least one signal.
18. The method of any preceding example, wherein obtaining position data for each transmission source comprises, looking up the identity associated with the moving transmission source in a data source and retrieving the position of the transmission source from the data source.
19. The method of example 18 wherein the data source is a database comprising position data for the moving transmission source.
20. The method of example 18 or example 19, wherein the database is located either:
a) on a memory stored on the device; or
b) on a public or private network with which the device is in communication.
21. The method of any preceding example, wherein the moving transmission source a Low Earth Orbit (LEO) satellite.
22. The method of example 21 wherein the data source includes orbital data and obtaining position data for each transmission source comprises determining the orbit of the moving transmission source and the location of the transmission source along that orbit when the respective signal was transmitted.
23. The method of any preceding example, wherein the signal associated with the moving transmission source comprises one or more of: radio time signals, television signals, radio signals, ad to hoc signals, navigational aids, communication signals and non to directional beacons.
24. A device configured to perform the method of any one of examples 1 to 23.
25. A computer to readable medium storing instructions that, when executed on a processor, cause the processor to perform the method of any one of examples 1 to 23.
26. A device comprising:
an antenna configured to receive signals of opportunity; an inertial measurement unit (IMU);
a processor;
the computer to readable medium of example 25.
27. A system comprising the device of example 24 or example 27 and a transmitter configured to broadcast a signal of opportunity from a source moving relative to the earth.
28. A method for determining the location of a transmission source of a signal of opportunity, the method comprising:
receiving, at one or more known locations, the signal of opportunity;
measuring a property of the signal received at the one or more known locations; and
determining a position data of the transmission source based on the measured property,
wherein the position data comprises a location of the transmission source.
29. The method of example 28, wherein the property of the signal comprises a time that the signal was transmitted from the transmission source and determining the position data of the transmission source comprises determining the difference between when the signal was transmitted from the transmission source and received at the one or more known locations.
30. The method of any one of examples 28 or 29, further comprising saving the position data in a database.
31. The method of example 30 wherein the database is saved on a device at any of the one or more locations or is located on a public or private network that devices can access for navigation.
32. The method of any one of examples 28 to 31, wherein the property of the signal comprises a phase of the signal as received at each of the one or more known locations.
33. The method of example 32 wherein a phase of the signals is at least one of a code phase of the signal or the phase of a carrier wave of the signal.
34. The method of example 32 or example 33 wherein determining position data of the transmission source comprises:
determining a change in phase of the signal of opportunity as received at the one or more locations; and
determining the position data of the transmission source based on the determined change in phase and one or more known locations.
35. The method of any one of examples 28 to 34, further comprising:
providing the position data of the transmission source to a device; and
determining, based on the location of the transmission source and a property of the signal as received at the one or more known locations, the location of the device.
36. The method of any one of examples 28 to 35, wherein the transmission source is one of: a satellite in orbit of the Earth, an aircraft in flight, a moving vehicle, a radio time transmission source, a communication signal transmission source, a television signal transmission source, an ad-hoc transmitter, a navigational aid or a non to directional beacon.
37. The method of any one of examples 28 to 36, wherein the position data further comprises a trajectory or a set of orbital parameters of the transmission source, wherein the trajectory or the set of orbital parameters enable the location of the transmission source at a later time to be calculated or predicted.
38. The method of example 37 further comprising:
determining a velocity of the transmission source relative to at least one of the one or more known locations; and
determining, based on the velocity of the transmission source and the location of the transmission source, the trajectory or the set or orbital parameters of the transmission source.
39. The method of any one of examples 28 to 38 wherein the location of the transmission source is determined using trilateration or multilateration.
40. The method of any one of examples 28 to 39, wherein the one or more locations comprises three or more locations.
41. The method of any one of examples 28 to 40, wherein determining the position data is further based on an approximate position data of the transmission source, wherein the approximate position data is any one of a previous position data of the transmission source that has since degraded or position data of the transmission source that has been retrieved from a database.
42. A method of determining the location of a device comprising:
determining the location of the device using signals from satellites that are part of a Global Navigation Satellite System (GNSS);
determining the location of a transmission source of a signal of opportunity that is not part of the GNSS using the method of any one of examples 28 to 41;
in response to the device no longer receiving signals from satellites that are part of the GNSS, determining the position of the device based on the signal of opportunity and the location of the transmission source.
43. The method of example 42 wherein determining the position of the device based on the signal of opportunity and the location of the transmission source comprises the method of any one of examples 1 to 23.
44. A computer readable medium storing instructions that, when executed on a processor in communication with a means of receiving a signal of opportunity, causes the processor to perform the method of any one of examples 28 to 43.
45. A system comprising:
one or more devices configured to receive a signal of opportunity, each device at a separate known location;
wherein each device of the one or more devices comprises a processor, each processor together configured to perform the method of any one of examples 28 to 43.

What is claimed is:

1. A method for determining a position of a device, the method comprising:
receiving, at the device, one or more signals of opportunity, wherein each signal of the one or more signals of opportunity originates from a different transmission source of one or more transmission sources, and wherein at least one transmission source of the one or more transmission sources is a moving transmission source moving relative to the earth;
determining an identity of each transmission source of the one or more transmission sources based on the respective signal of the one or more signals of opportunity;
obtaining position data for each transmission source based on the identity of the transmission source; and
determining the position of the device based on a respective property of each signal of the one or more signals of opportunity and the position data for each of the one or more transmission sources.

2. The method of claim 1, wherein:
the device comprises an inertial measurement unit (IMU); and
the position of the device is further determined based on data from the IMU.

3. The method of claim 2, wherein determining the position of the device comprises:
determining a first distance from the device to at least one transmission source of the one or more transmission sources based on the respective property of the signal of opportunity associated with the at least one transmission source;
determining a first locus of points on which the device may be positioned based on the first distance and the position data of the at least one transmission source;
receiving, at the device, an additional signal of opportunity at a later time from the at least one transmission source;
obtaining second position data for the at least one transmission source based on the identity of the at least one transmission source;
determining a second distance from the device to the at least one transmission source based on the respective property of the additional signal of opportunity;
determining a second locus of points on which the device may be positioned at the later time based on the second distance and the second position data; and
determining the position of the device based on the first locus of points, the second locus of points, and the data from the IMU.

4. The method of claim 3, wherein determining the position of the device based on the first locus of points, the second locus of points, and the data from the IMU comprises:
determining a movement vector of the device over a period of time from receiving the one or more signals of opportunity to receiving the additional signal of opportunity based on the data from the IMU;
aligning the movement vector with the first locus of points and the second locus of points such that the movement vector begins on the first locus of points and ends on the second locus of points;
determining the position of the device when the one or more signals of opportunity were received as the position on the first locus of points that the movement vector begins; and
determining the position of the device at the later time as the position on the second locus of points that the movement vector ends.

5. The method of claim 2, wherein the position of the device is further determined based on a previously-known position of the device stored in a memory of the device.

6. The method of claim 5, wherein determining the position of the device comprises:
determining a distance from the device to at least one transmission source of the one or more transmission sources based on the respective property of the signal of opportunity associated with the at least one transmission source;
determining a locus of points on which the device may be positioned based on the distance from the device to the at least one transmission source; and
determining the position of the device based on the locus of points, data from the IMU, and the previously-known position.

7. The method of claim 6, wherein determining the position of the device based on the locus of points, the data from the IMU, and the previously-known position comprises combining the data from the IMU and the locus of points using a Kalman filter or a complementary filter.

8. The method of claim 5, wherein, for at least one signal of the one or more signals of opportunity, the property of the signal comprises at least one of: timing information or a phase of the signal.

9. The method of claim 8, wherein the phase of the signal is at least one of: a code phase of the signal or a phase of a carrier wave of the signal.

10. The method of claim 8, wherein determining the position of the device comprises:
determining a change in phase of the signal of opportunity associated with at least one transmission source of the one or more transmission sources; and
determining the position of the device based on the determined change in phase and the position data of the at least one transmission source.

11. The method of claim 10, wherein determining the position of the device based on the determined change in phase and the position data of the at least one transmission source comprises:
determining a speed of the device relative to the at least one transmission source based on the change in phase of the signal of opportunity;
combining the data from the IMU and the speed of the device to produce a velocity vector; and
adding the velocity vector to the previously-known position to determine the position of the device.

12. The method of claim 11, wherein combining the data from the IMU and the speed of the device comprises combining the data from the IMU and the speed of the device using at least one of: a Kalman filter, a complementary filter, or a weighted sum.

13. The method of claim 2, wherein:
the one or more transmission sources include one moving transmission source; and
the one or more signals of opportunity include one signal of opportunity associated with the moving transmission source.

14. The method of claim 1, wherein obtaining the position data for each transmission source comprises identifying, from at least one signal of the one or more signals of opportunity, position data of the respective transmission source of the at least one signal.

15. The method of claim 1, wherein obtaining the position data for each transmission source comprises:
looking up the identity associated with the moving transmission source in a data source; and
retrieving the position data of the transmission source from the data source.

16. The method of claim 15, wherein the moving transmission source is a Low Earth Orbit (LEO) satellite.

17. The method of claim 16, wherein:
the data source includes orbital data; and
obtaining the position data for each transmission source comprises determining an orbit of the moving transmission source and a location of the transmission source along that orbit when the respective signal was transmitted.

18. A device comprising:
an antenna configured to receive one or more signals of opportunity, wherein each signal of the one or more signals of opportunity originates from a different transmission source of one or more transmission sources, and wherein at least one transmission source of the one or more transmission sources is a moving transmission source moving relative to the earth; and
a processor configured to:
determine an identity of each transmission source of the one or more transmission sources based on the respective signal of the one or more signals of opportunity;
obtain position data for each transmission source based on the identity of the transmission source; and
determine a position of the device based on a respective property of each signal of the one or more signals of opportunity and the position data for each of the one or more transmission sources.

19. The device of claim 18, wherein:
the device further comprises an inertial measurement unit (IMU); and
the processor is configured to determine the position of the device based on data from the IMU.

20. A non-transitory machine readable medium containing instructions that when executed cause a processor of a device to:
obtain, at the device, one or more signals of opportunity, wherein each signal of the one or more signals of opportunity originates from a different transmission source of one or more transmission sources, and wherein at least one transmission source of the one or more transmission sources is a moving transmission source moving relative to the earth;
determine an identity of each transmission source of the one or more transmission sources based on the respective signal of the one or more signals of opportunity;
obtain position data for each transmission source based on the identity of the transmission source; and
determine a position of the device based on a respective property of each signal of the one or more signals of opportunity and the position data for each of the one or more transmission sources.
